(19) United States
(12) Patent Application Publication
(10) Pub. No.: US 2025/0242889 A1
(43) Pub. Date: Jul. 31, 2025

(54) Shifting Device and Bicycle

(71) Applicant: MA Micro Limited, London (GB)

(72) Inventors: Yu-Lun Chao, London (GB); Chien-Cheng Kung, London (GB); Olivier Hébert, London (GB); David Alexander Enthoven, London (GB); Ahmet Serhan Kuscuoglu, London (GB); Chien I Chen, London (GB)

(21) Appl. No.: 18/848,672

(22) PCT Filed: Mar. 20, 2023
(86) PCT No.: PCT/NL2023/050142

§ 371 Date: Sep. 19, 2024

(30) Foreign Application Priority Data
Mar. 21, 2022 (NL) 2031357

(51) Int. Cl. B62M 25/08; B62J 45/413; B62M 25/00

(52) U.S. Cl. CPC B62M 25/08; B62J 45/413; B62M 2025/006

(57) ABSTRACT

The present invention relates to a bicycle with a central controlling computer, including a bicycle shifting device for shifting of a bicycle gear, including a shifting control unit for receiving of shifting instructions from the central controlling computer or a further control unit, a power receiving module, such as including an electrical connector, at least one shifting motor, for providing a shifting motion for driving a shifting assembly for actuating of a gear actuator, the shifting assembly being configured to transfer the shifting motion from the shifting motor to the gear actuator, the gear actuator being configured to transfer the shifting motion to the bicycle gear, The shifting control unit, by means of communication with and controlling by the central controlling computer of the bicycle, is configured as a subsystem of the bicycle, and the shifting control unit shifts the bicycle gear on the basis of primary shifting instructions and/or secondary shifting instructions from the main control unit, the motor control unit, and/or a further control unit.

### CROSS-REFERENCE TO RELATED APPLICATIONS

This application is the United States national phase of International Patent Application No. PCT/NL2023/050142 filed Mar. 20, 2023, and claims priority to The Netherlands Patent Application No. 2031357 filed Mar. 21, 2022, the disclosures of which are hereby incorporated by reference in their entireties.

### BACKGROUND OF THE INVENTION

### Field of the Invention

The present invention relates to a bicycle with a central controlling computer, such as a central board computer, for controlling subsystems of the bicycle, such as lights, a sound system, a drive motor, a battery management system and/or a security system, such as comprising a power on/of a position function, the bicycle comprising a bicycle shifting device for shifting of a bicycle gear, such as a hub gear. The invention also relates to a bicycle shifting device for use in a bicycle according to the invention, as well as to a method for performing shifting of gears of a bicycle, preferably with a bicycle according to the invention. The present invention preferably relates to a bicycle with an electric drive motor for preferably assisting the rider with its power.

### Description of Related Art

Bicycle gears have been well-known to be used on bikes and electric bikes. With PCT/NL2021/050253, the present inventor and delivered a new approach of an integrated electric shifter aimed at automatically shifting the gears of the bicycle during riding thereof in a way that is more practical to operate the manual gears for such bicycle. Since, the present inventor has endeavoured to improve upon that concept as certain aspects were thought of to be able to be improved for the benefit of the rider of the bicycle.

### SUMMARY OF THE INVENTION

As such, it has been an object of the present invention to devise a shifting device that is able to continuously monitor a position of a gear actuator.

Furthermore, it has been an objective to devise a shifting device that is able to perform a calibration or a just a 0 setting regularly, such as during a bootup of the device or a bootup the bicycle.

Furthermore, it has been an object of the invention to allow for a shifting device that is able to shift faster or more reliably, such as by means of an improved timing of shifting.

To achieve at least one of these objects, the invention provides a bicycle or electric bicycle with a central controlling computer, such as a central board computer and/or main control unit, for controlling subsystems of the bicycle, such as lights, a sounds system, a drive motor, a battery management system and/or a security system, such as comprising a power on/of a position function, the bicycle comprising a bicycle shifting device for shifting of a bicycle gear, such as a hub gear, the bicycle shifting device comprising:
at least one shifting control unit for receiving of shifting instructions from the central controlling computer or a further control unit, comprising a processing unit and a memory,
at least one power receiving module, such as comprising an electrical connector, for receiving power from a battery of the central controlling computer, and/or main control unit, and/or a drive motor battery of the bicycle,
at least one shifting motor, such as an electric motor for providing a shifting motion for driving at least one shifting assembly for actuating of a gear actuator,
the shifting assembly being configured to transfer the shifting motion from the shifting motor to the gear actuator,
the gear actuator being configured to transfer the shifting motion to the bicycle gear, wherein:
   the shifting control unit, preferably by means of communication with and controlling by the central controlling computer of the bicycle, is configured as a subsystem of the bicycle, and
   the shifting control unit shifts or is configured to shift the bicycle gear on the basis of primary and/or secondary shifting instructions from the central controlling computer, and/or the main control unit, and/or the motor control unit, and/or a further control unit.

It is an advantage of the present invention that shifting of the gears is performed based on improved instructions from the central board computer. It is preferred that the primary shifting instructions are based on information that affects the rider of the bicycle. Such information is related to information relating to the rotational speed of the pedals as the gears are intended to allow pedalling within a lower and upper threshold of such rotational speed furthermore, the gears are intended to allow pedalling between a lower and upper threshold of muscle force that is to be exerted on to the pedals. Such optimal values of rotational speed and muscle force are influenced by the bicycle speed and by an inclination the bicycle is riding on. When the bicycle is riding on and inclining road, the muscle forces need to be relatively high whereas at a declining road, the muscle forces may be relatively low in relation to this speed. With this in mind, it is preferred that the primary instructions provide instructions as to required shifting by the bicycle shifting device in a way that is predetermined to be comfortable for the rider. It is also considered that a rider may provide rider specific settings as to what the rider considers comfortable.

The bicycle according to the invention preferably comprises a central controlling computer, such as a central board computer, for controlling subsystems of the bicycle, such as lights, a sound system, a drive motor, a battery management system and/or a security system, such as comprising a power on/of a position function, the bicycle comprising a bicycle shifting device for shifting of a bicycle gear, such as a hub gear, the bicycle shifting device comprising:
a shifting control unit for receiving of shifting instructions from the central controlling computer or a further control unit, comprising a processing unit and a memory,
a power receiving module, such as comprising an electrical connector, for receiving power from a battery of the central controlling computer and/or a drive motor battery of the bicycle,
at least one shifting motor, such as an electric motor, such as a stepper motor for providing a shifting motion for driving a shifting assembly for actuating of a rotatable gear actuator of the bicycle shifting device,
the shifting assembly being configured to transfer the shifting motion from the shifting motor to the gear actuator,
the gear actuator being configured to transfer the shifting motion to the bicycle gear, wherein:
   the shifting control unit, by means of communication with and controlling by the central controlling computer of the bicycle, is configured as a subsystem of the bicycle, and
   the shifting control unit shifts the bicycle gear on the basis of shifting instructions, in particular primary shifting instructions and/or secondary shifting instructions, from the central controlling computer, the motor control unit, and/or a further control unit,
wherein the bicycle shifting device comprises a positioning determining assembly, such as an angular position determining assembly, for determining of an absolute position, such as an absolute position or an absolute angular position, of the gear actuator relative to at least one sensor of the positioning determining assembly, and wherein the positioning determining assembly comprises the at least one, preferably at least two, magnetic field sensor, preferably at least one Hall sensor or at least one 2D hall sensor, for performing magnetic field measurements, and wherein the gear actuator is provided with an annular array of consecutive magnets along its substantially entire circumference or periphery, wherein most of said magnets of said annular array are arranged in an alternately north-south arrangement, and wherein the remaining magnets define at least one series of at least two consecutive magnets having the same polarity arrangement.

Within this understanding, the primary instructions are preferably provided to the bicycle shifting device or shifting control unit thereof by preferably the central controlling computer, also indicated below as the first control unit.

Secondary shifting instructions are preferably provided in order to facilitate the shifting action of the bicycle shifting device. For this, it is preferably considered that shifting may be hampered by a high load exerted on the drivetrain of the bicycle such as during forcefully pedalling. From this observation, it is an objective of the present invention to prevent shifting under such high loads. To this end, the bicycle is preferably provided with a torque sensor of which the sensor values preferably form the basis of such secondary shifting instructions. A preferred underlying notion to this end is that pedalling is a cyclical action performed on the pedals of the bicycle, and that during a rotational cycle of the bicycle more force is exerted to the pedal and the pedal is in horizontal orientation then when the pedal is in vertical orientation. From this, it is a derives objective of the present invention to have the bicycle shifting device shift the gears during such part of the pedalling cycle in which the forces are low and/or the pedals are generally in vertical orientation.

Preferably, the annular array of magnets comprises at least one series of at least three consecutive magnets having the same polarity arrangement, such as a north-north-north arrangement or a south-south-south arrangement. It is additionally or alternatively, also preferable that the annular array of magnets comprises at least two series of at least two (or at least three) consecutive magnets having the same polarity arrangement. Preferably, each series of at least three consecutive magnets having the same polarity arrangement, is positioned at a predefined location of the annular array of the gear actuator. The series of magnets having a uniform polarity will be detected as distinctive and/or discriminatory magnet arrangement by the magnetic field sensor(s), which provides the sensor information relating to the actual angular position (orientation) of the gear actuator. In this way, the shifting device always knows or is always aware of its absolute angular position. Moreover, the continuous annular array of magnets, including the at least one discriminatory series of magnets, makes the shifting device self-calibrating in a relatively autonomous, fast manner, even after a power interruption.

According to a first preferred embodiment, of the bicycle, the bicycle shifting device comprises a positioning determining assembly, such as an angular position determining assembly, for determining of a position, such as an absolute position or an absolute angular position of the gear actuator relative to at least one sensor. A further object of the present invention is to improve shifting accuracy or shifting dependency relative to the above cited version. The positioning determining assembly according to the present embodiment provides information as to the position of the gear actuator. As the gear actuator is fixed to the gears, with such position information, it is monitored in what position there gear actuator is, and this in what position the gear is. With this, the electric motor may be actuated while also monitoring of the position is performed and as such, the shifting control unit is able to actuate shifting control in order to correctly orient the gear actuator at the end of a shifting action. Any shifting action is a shifting action of at least one gear up or at least one gear down.

According to a further preferred embodiment, the positioning determining assembly comprises the at least one, preferably two, sensors, such as at least one magnetic field sensor, such as at least one Hall sensor or at least one 2D hall sensor, for performing magnetic field measurements, and wherein the gear actuator is provided with an array of consecutive magnets along its circumference or periphery, preferably wherein the magnets are arranged in an alternately north-south arrangement, further preferably with at least one exception of such arrangement. With such sensor configuration, a preferred resolution of positioning determining or positioning monitoring is achieved in order to actuate the shifting motor for accurate shifting.

Further preferably, with such configuration, two sensors are arranged at a mutual distance for detecting passage of consecutive magnets, such as at a distance smaller than the mutual distance of two consecutive magnets. This configuration is the presently preferred configuration for analysing signals detected by the sensors for reliable input data for controlling of the at least one shifting motor.

Preferably, the positioning determining assembly comprises at least two hall sensors, mutually positioned at a distance d, and wherein at least one series of at least two consecutive magnets having the same polarity arrangement has a width, in particular a curved width, wherein said width exceeds said distance d between said at least two hall sensors. In this manner, the two sensors can and will simultaneously identify the same series of magnets with the same polarity arrangements, which increases the reliability and/or accuracy of the shifting device. Preferably, the shortest distance between at least one sensor and the annular array of magnets is smaller than the width of at least one magnet. This will commonly be in favour of the performance of the sensors, and hence of the shifting device.

According to a further preferred embodiment, the bicycle comprises program code, preferably operational on the shifting control unit, for analysing sensor data of the at least one sensor, arranged for determining the position of the gear actuator based on the measurements of the sensor on the array of consecutive magnets. For the purpose of the monitoring of the location of the gear actuator, sensor data is preferably analysed. It is preferred that such analysis is performed at the bicycle shifting device, such as in the shifting control unit, as the sensor data is used for controlling of the at least one shifting motor. Alternatively, it is preferred that such analysis is performed at the central controlling computer. This is for example preferred as the central controlling computer preferably provides the primary shifting instructions.

According to a further preferred embodiment, the bicycle comprises a torque sensor for measuring a torque exerted by means of pedalling power by the rider of the bicycle as providing a torque measurement signal, the torque sensor preferably being arranged at the crankshaft of the bicycle, the shifting control unit being arranged for receiving the torque measurement signal originating from the torque sensor. The above indicated objective pertaining to the secondary shifting instructions is directed at such embodiment.

Further preferably, the shifting control unit is configured receive a secondary shifting instruction to prevent shifting when the torque measurement signal indicates a torque above a threshold value, and to allow shifting when the torque measurement signal indicates a torque below a threshold value. Such secondary shifting instruction, as indicated in the above, is based on sensor data of the torque sensor, as will be explained in greater detail below. An advantage of such embodiment is that shifting of the gears during a high loads on the gears by for example muscle power is prevented.

A preferred way of implementing this is that the shifting control unit is configured to prevent shifting unless a low load meaning input is received or a timing thereof is received. Such timing may be provided based on the cyclic nature of pedalling during periods in which pedalling is performed. A preferred embodiments comprising a predictor module for predicting of a time period during which the torque will be below the threshold value, such as based on a repetitive nature of the torque measurement signal, preferably operational in the shifting control unit, the controlling computer and/or a further control unit of the bicycle, provides such advantage. During periods in which no pedalling is performed, a low load situation is constantly present. It is preferred that such low load situation is also provided to the bicycle shifting device or shifting control unit thereof. As soon as a pedalling force is renewedly detected, a high loads status is preferably provided as a secondary instruction immediately to the bicycle shifting device. Such secondary shifting instructions are preferably provided to the bicycle shifting device directly from a processor performing analysis of raw data from the torque sensor. It is preferred to have such processor present at the location of the torque sensor, such as at the crankshaft of the bicycle. Alternatively, it is considered to have such sensor data transferred to the central controlling computer of the bicycle or to be shifting control unit directly.

According to a further preferred embodiment, the bicycle shifting device and or the shifting control unit thereof is configured to only initiate and/or perform a shifting after receipt of at least one preferably primary shifting instruction from the central controlling computer and/or a preferably secondary shifting instruction comprising a torque measurement signal.

Preferably, the bicycle comprises a torque sensor for measuring a torque exerted by means of pedalling power by the rider of the bicycle as providing a torque measurement signal, the torque sensor preferably being arranged at the crankshaft of the bicycle, the shifting control unit being arranged for receiving the torque measurement signal originating from the torque sensor, and wherein the bicycle comprises a speed sensor for measuring the speed of the bicycle and configured to provide a speed measurement signal, the shifting control unit being arranged for receiving the speed measurement signal originating from the speed sensor, and wherein at least one control unit, such as the central controlling computer and/or shifting control unit, is configured to provide a shifting instruction based upon the combination of the collected torque measurement signal and the collected speed measurement signal. Hence, by measuring two or more parameters, such as torque, speed, inclination, etcetera, by using different sensors, and by combining the provided sensor signals in order to subsequently generate at least one shifting instruction, will lead to a relatively sophisticated shifting process. This allows the shifting device for example to determine the best shifting moment to protect shifting device itself and the hub, and will commonly improve the riding behaviour and experience. Moreover, the shifting device according to the invention allows faster shifting, which leads to shorter moments of not pedalling, which will also be experienced as positive and desired by riders.

According to a further preferred embodiment, the bicycle comprises a storage and processing module for a rider defined shifting profile, preferably embodied as stored and processed at the central controlling computer. With this embodiment, it is achieved that a rider that wants a relatively light or relatively strenuous effort profile to be accommodated. It is advantageously achieved with such embodiment that this basic information that may pertain to a specific gear device may be updated when the gear device was subject to maintenance, revising or exchanging.

According to a further preferred embodiment, the bicycle comprises a, preferably, programmable, such as during maintenance, data store comprising data indicating for each gear the position the gear actuator should have. This information is preferably related to the position information as provided by the positioning determining assembly or the at least one sensor thereof.

According to a further preferred embodiment, the bicycle comprises a control unit, such a the shifter control unit or central controlling computer, that is configured to perform a bootup sequence comprising steps of:
displacing, such as rotating the gear actuator to an end of its rotational path, preferably determined by the termination of a motor current exceeding a current threshold,
determining this end of its rotational path as calibration point or start point of functioning from bootup,
preferably subsequently rotating the gear actuator to the position of the lowest or first gear. With this, it is preferably achieved to calibrate the position, absolute position and/or the absolute angular position of the gear actuator relative to the at least one sensor. This provides a very high reliability of shifting accuracy over the lifespan of the bicycle, gears and/or bicycle shifting device.

According to a further preferred embodiment, the bicycle comprises a control unit configured to perform a monitoring sequence comprising steps of continuously monitoring the position or angular position of the gear actuator by the sensor, such as from a bootup of the device, this provides accurate information as to the location of the gear actuator.

According to a further preferred embodiment, the bicycle comprises a control unit configured to perform controlling of the shifting motor based on the continuous monitoring of the position or angular position of the gear actuator by the sensor. With this, it is preferably advantageously achieved that an accurate shifting motion is provided to the gear actuator, such as accurate from a bootup of the device.

According to a further preferred embodiment, the bicycle comprises a central control unit configured to perform assembling shifting instructions, preferably by the central controlling computer, for the shifting control unit. With this, the shifting instructions, preferably the primary shifting instructions are based on central control operations of the bicycle. This is for example advantageous as such central control of the bicycle is capable of controlling the shifting in line with controlling of the subsystems, such as the drive motor, the lock, the battery management system, lights, sounds.

According to a further preferred embodiment, the bicycle comprises a further control unit configured to perform monitoring the bicycle speed, preferably by the central controlling computer, preferably based on rotational information provided by the drive motor of the bicycle or sensors thereof, preferably as an input for the central controlling computer as input parameter to determine a shifting moment based on the speed of the bicycle.

According to a further preferred embodiment, the bicycle comprises a further control unit configured to perform monitoring an inclination sensor of the bicycle as an input in order to perform determining of a shifting moment also based on the inclination of the bicycle.

Preferably, in such a bicycle, the bicycle gear is a hub gear arranged in the rear hub of the bicycle. According to a further preferred embodiment, the bicycle comprises a temperature sensor for sensing a temperature in the bicycle shifting device, preferably sensing a temperature of the at least one shifting motor. With this, shifting may be advantageously prevented based on sensor data indicating an overload of the bicycle shifting device or the at least one shifting motor thereof.

A further aspect according to the present invention relates to a method for performing shifting of gears of a bicycle, preferably with a bicycle according to the invention, the method comprising steps of:
monitoring at least one sensor of a group of sensors comprising a gear actuator position sensor which is preferably embodied as at least one, preferably two Hall sensors, a speed sensor, a torque sensor, and inclination sensor, by respectively a central controlling computer, a shifting control unit or a further control unit of the bicycle.
assembling a primary shifting instruction indicating shifting of at least one gear up or down,
preferably assembling a secondary shifting instruction indicative of a torque threshold value,
controlling of a shifting motor based on the respective shifting instructions.

Advantages of such aspect according to the present invention are described in relation to the above aspects.

A first preferred embodiment relates to a method comprising a calibration and/or bootup sequence comprising steps of:
rotating the gear actuator to an end of its rotational path, preferably determined by the termination of a motor current exceeding a current threshold,
determining this end of its rotational path as calibration point or start point of functioning from bootup,
preferably rotating the gear actuator to the position of the lowest or first gear.

Such preferred embodiment provides the advantage that a calibrated location the termination of the gear actuator is advantageously achieved from each such performing of such bootup sequence.

The invention also relates to a bicycle shifting device for use in a bicycle according to the invention.

Preferred embodiments of the invention are set out in the non-limitative set of embodiments presents below:
1. Bicycle with a central controlling computer, such as a central board computer, for controlling subsystems of the bicycle, such as lights, a sound system, a drive motor, a battery management system and/or a security system, such as comprising a power on/of a position function, the bicycle comprising a bicycle shifting device for shifting of a bicycle gear, such as a hub gear, the bicycle shifting device comprising:
a shifting control unit for receiving of shifting instructions from the central controlling computer or a further control unit, comprising a processing unit and a memory,
a power receiving module, such as comprising an electrical connector, for receiving power from a battery of the main control unit and/or a drive motor battery of the bicycle,
at least one shifting motor, such as an electric motor, such as a stepper motor for providing a shifting motion for driving a shifting assembly for actuating of a gear actuator,
the shifting assembly being configured to transfer the shifting motion from the shifting motor to the gear actuator,
the gear actuator being configured to transfer the shifting motion to the bicycle gear, wherein:
   the shifting control unit, by means of communication with and controlling by the central controlling computer of the bicycle, is configured as a subsystem of the bicycle, and
   the shifting control unit shifts the bicycle gear on the basis of primary shifting instructions and/or secondary shifting instructions from the main control unit, the motor control unit, and/or a further control unit.
2. Bicycle according to embodiment 1 in which the bicycle shifting device comprises a positioning determining assembly, such as an angular position determining assembly, for determining of a position, such as an absolute position or an absolute angular position of the gear actuator relative to at least one sensor.
3. Bicycle according to embodiment 2 wherein the positioning determining assembly comprises the at least one, preferably two, sensors, such as at least one magnetic field sensor, such as at least one Hall sensor or at least one 2D hall sensor, for performing magnetic field measurements, and wherein the gear actuator is provided with an array of consecutive magnets along its circumference or periphery, preferably wherein the magnets are arranged in an alternately north-south arrangement, further preferably with at least one exception of such arrangement.
4. Bicycle according to embodiment 3 in which two sensors are arranged at a mutual distance for detecting passage of consecutive magnets, such as at a distance smaller than the mutual distance of two consecutive magnets.
5. Bicycle according to any of the preceding embodiments comprising program code, preferably operational on the shifting control unit, for analysing sensor data of the at least one sensor, arranged for determining the position of the gear actuator based on the measurements of the sensor on the array of consecutive magnets.
6. Bicycle according to any of the preceding embodiments comprising a torque sensor for measuring a torque exerted by means of pedalling power by the rider of the bicycle as providing a torque measurement signal, the torque sensor preferably being arranged at the crankshaft of the bicycle, the shifting control unit being arranged for receiving the torque measurement signal originating from the torque sensor.
7. Bicycle according to embodiment 6 in which the shifting control unit is configured receive a secondary shifting instruction to prevent shifting when the torque measurement signal indicates a torque above a threshold value, and to allow shifting when the torque measurement signal indicates a torque below a threshold value.
8. Bicycle according to embodiment 6 or 7 comprising a predictor module for predicting of a time period during which the torque will be below the threshold value, such as based on a repetitive nature of the torque measurement signal, preferably operational in the shifting control unit, the controlling computer and/or a further control unit of the bicycle.
9. Bicycle according to any of the preceding embodiments wherein the shifting control unit only initiates and/or performs a shifting after receipt of at least one preferably primary shifting instruction from the central controlling computer and/or a preferably secondary shifting instruction comprising a torque measurement signal.
10. Bicycle according to any of the preceding embodiments comprising a storage and processing module for a rider defined shifting profile, preferably embodied as stored and processed at the central controlling computer.
11. Bicycle according to any of the preceding embodiments having a, preferably, programmable, such as during maintenance, data store comprising data indicating for each gear the position the gear actuator should have, preferably relative to a calibration point or start point.
12. Bicycle according to any of the preceding embodiments having a control unit, such a the shifter control unit or central controlling computer, that is configured to perform a bootup sequence comprising steps of:
displacing, such as rotating the gear actuator to an end of its rotational path, preferably determined by the termination of a motor current exceeding a current threshold,
determining this end of its rotational path as the calibration point or the start point of functioning from bootup,
preferably subsequently rotating the gear actuator to the position of the lowest or first gear.
13. Bicycle according to any of the preceding embodiments having a control unit configured to perform a monitoring sequence comprising steps of continuously monitoring the position or angular position of the gear actuator by the sensor.
14. Bicycle according to embodiment 13 having a control unit configured to perform controlling of the shifting motor based on the continuous monitoring of the position or angular position of the gear actuator by the sensor.
15. Bicycle according to any of the preceding embodiments comprising as control unit configured to perform assembling shifting instructions, preferably by the central controlling computer, for the shifting control unit.
16. Bicycle according to any of the preceding embodiments comprising a control unit configured to perform monitoring the bicycle speed, preferably by the central controlling computer, preferably based on rotational information provided by the drive motor of the bicycle or sensors thereof, as an input in order to determine a shifting moment based on the speed of the bicycle.
17. Bicycle according to any of the preceding embodiments comprising a further control unit configured to perform monitoring an inclination sensor of the bicycle as an input in order to perform determining of a shifting moment also based on the inclination of the bicycle.
18. Bicycle according to any of the preceding embodiments in which the bicycle gear is a hub gear arranged in the rear hub of the bicycle
19. Bicycle according to any of the preceding embodiments comprising a temperature sensor for sensing a temperature in the bicycle shifting device, preferably sensing a temperature of the at least one shifting motor.
20. Method for performing shifting of gears of a bicycle, preferably with a bicycle according to one or more of the above embodiments, the method comprising steps of:
monitoring at least one sensor of a group of sensors comprising a gear actuator position sensor which is preferably embodied as at least one, preferably two Hall sensors, a speed sensor, a torque sensor, and inclination sensor, by respectively a central controlling computer, a shifting control unit or a further control unit of the bicycle.
assembling a primary shifting instruction indicating shifting of at least one gear up or down,
preferably assembling a secondary shifting instruction indicative of a torque threshold value,
controlling of a shifting motor based on the respective shifting instructions.
21. Method for performing shifting of gears according to embodiment 20 comprising a calibration and/or bootup sequence comprising steps of:
rotating the gear actuator to an end of its rotational path, preferably determined by the termination of a motor current exceeding a current threshold,
determining this end of its rotational path as calibration point or start point of functioning from bootup,
preferably rotating the gear actuator to the position of the lowest or first gear.

### BRIEF DESCRIPTION OF THE DRAWINGS

The terms Fig., Figs., Figure, and Figures are used interchangeably in the specification to refer to the corresponding figures in the drawings.

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

FIGS. 1A-B relate to a perspective views of a first preferred embodiment according to the present invention.

FIGS. 2A-B relate to partly exploded side views of the embodiment according to FIGS. 1A-B.

FIGS. 3A-B relate to perspective views of a detail of the preferred embodiment according to FIGS. 1A-B.

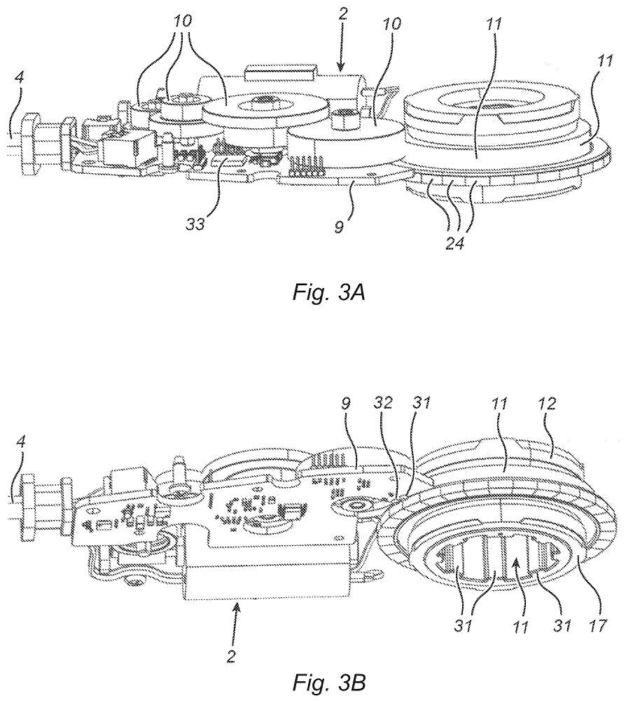

FIG. 4 provides a schematic representation of a further preferred embodiment according to the present invention.

FIG. 5 provides a schematic representation of a further preferred embodiment according to the present invention.

FIGS. 6A-B provide schematic representation of preferred shifting moments according to a further preferred embodiment according to the present invention.

FIGS. 7A-D provide a flow chart of operating steps components of a preferred embodiment according to the present invention.

FIG. 8 provides a state diagram of a further preferred embodiment according to the present invention.

FIG. 9 provides a flow diagram of a further preferred embodiment according to the present invention.

FIGS. 10A-B provide a sensor interpretation reference according to a preferred embodiment according to the present invention.

FIG. 11 provides a general representation of a bicycle equipped with a preferred embodiment according to the present invention.

### DESCRIPTION OF THE INVENTION

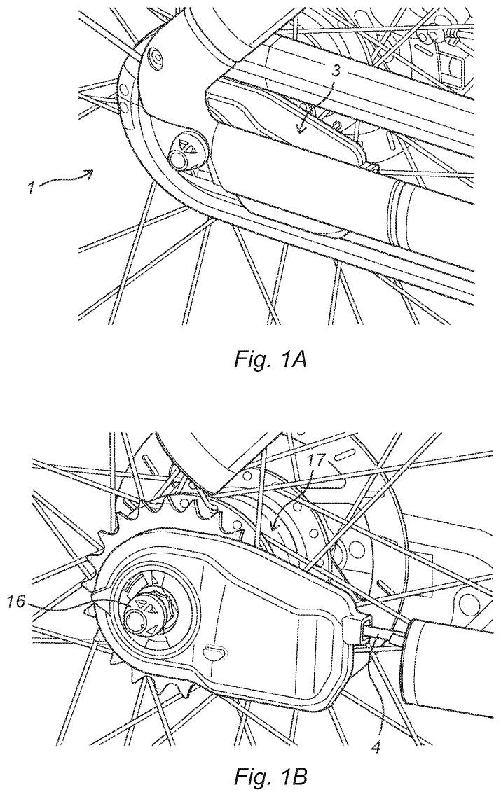

A first preferred embodiment (FIGS. 1A-B) according to the present invention relates to a gear shifting device 3 of a bicycle 1. It comprises a connection 4 with a main controlling computer 14 by means of a wire. The gear shifting device of 3 is arranged between the bottom stay of the bicycle and the hub 17 of the bicycle. The gear shifting device 3 is arranged in a housing comprising generally a PCB 9 comprising electronic components and a connector 18 for connecting to the wire 4. A shifting motor to is also arranged in the housing and via a worm 8 coupled to a gear assembly 10 for driving of a gear actuator 11. The gear actuator 11 is arranged between two bushings, a first bushing 12 and second bushing 17 for fixing the gear actuator 11 rotatably. The first bushing 12 is provided with an opening relative to the rear axle of the bicycle and for letting through the axle of the bicycle.

The gear shifting device 3 also comprises a shifting control unit 33 on that performs controlling of the shifting by means of receiving shifting instructions, primary shifting instructions and/or secondary shifting instructions. As a protective measure, the gear shifting device 3 has a temperature sensor 39 that is arranged next to the shifting motor for measuring the temperature of the shifting motor and providing temperature measurements to the controller 33. In case the shifting motor overheats, the controller 33 seizes driving this motor for the. The temperature is too high.

From the main controlling computer of the bicycle, the shifting device 3 is controlled. To this end, the shifting control unit 33 of the shifting device that is embodied on the circuit board 9, controls the shifting motor 2 for each shifting of the bicycle gear by means of providing power to the motor that is also obtained via the connection 4. The shifting motor 2 drives the worm 8 which causes the gear assembly 10 to be set into motion by means of the shifting motion of the shifting motor 2. With this, the gear actuator 11 is driven rotatably to drive to gear towards the next gear. The gear actuator has transmission cams 31 for transferring the motion to the bicycle gear by means of thereto suitable corresponding cams of the bicycle gear.

The gear actuator 11 has a number of magnets 24 along its circumference for actuating of a respective at least one hall sensor, in this example two Hall sensors 31, 32 that are arranged at the circuit board 9. With this, the shifting control unit is provided with information relating to the position of the gear actuator.

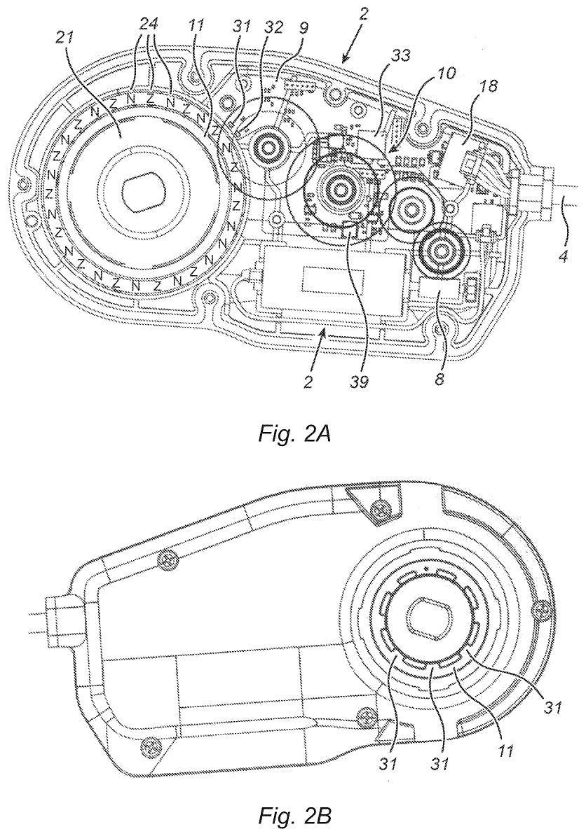

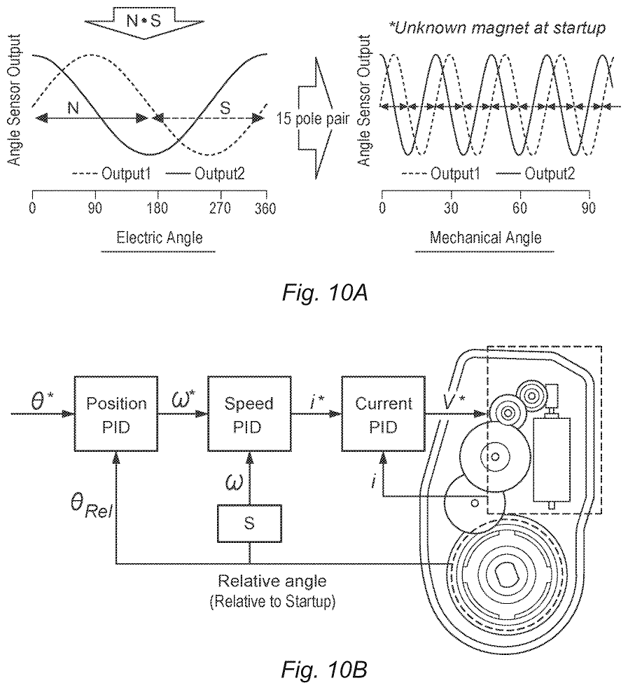

The magnets along the circumference are generally arranged in an alternately north (N)-south (Z) arrangement, as shown in FIG. 2A. In the example, at 2 positions along the circumference, the alternately north-south arrangement is interrupted by having at least one magnet or series of magnets arranged in the same orientation as its neighbours. The objective of such interruption is to have a position determining of such interruption during processing of such interruption along the sensors 31, 32. With such alternately north-south arrangement, the processing of the respective magnets along the Jewel Hall sensors provides a specific signal measurement profile, such as is indicated in FIG. 10A-B, that is instrumental in providing a measurement of a mechanical angle based on a relation between an electric angle directly derives from the sensor data and a mechanical angle derived from the electric angle. A relative angle is determined relative to a 0 point measurement that is determined during a calibration or bootup sequence of the bicycle, in particular the shifting control unit thereof. It is preferred that such calibration is performed at each bootup, however it is also envisaged to perform such calibration after a certain amount of time of use, such as during a momentary stop in between a ride.

The controlling of the shifting device 1′ is preferably performed from the central controlling computer 14 of the bicycle. The central controlling computer 14 of the bicycle determines shifting moments depending from predetermined parameters. Such predetermined parameters include the speed of the bicycle and or thereof derived parameters as to acceleration or deceleration of the bicycle. In acceleration and deceleration of the bicycle may be derived from variations in the speed or from an omnidirectional he sends for that is preferably arranged at the central controlling computer. A further parameter includes the inclination the bicycle is riding at. The control unit of the drive motor 13 for example provides information with respect to power of the motor and/or speed of the bicycle. A torque sensor that is preferably arranged at the crank set of the bicycle provides information relating to the pedalling force and/or pedalling speed.

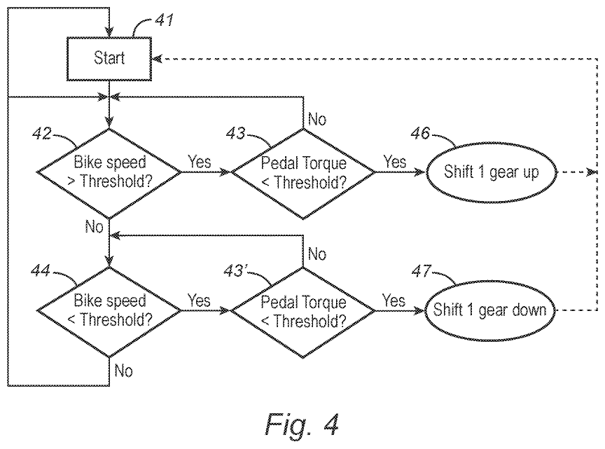

FIG. 4 shows a general basic flow of an embodiment as to determining the basics of a primary shifting instruction and the basics of a secondary shifting instruction in combination. This flow is performed as long as the bike is in a status or scenario for regular riding. Performing of this flow is listed when the bike changes from the status or scenario for regular riding to another status or scenario. It is expressly clarified here that although this embodiment expresses a combination of primary and secondary shifting instructions, it is presently preferred that these instructions are provided by different processors of the bicycle based on different inputs, such as input from centaurs or input from settings, provided by the bicycle. The flow starts in step 41. In step 42, it is determined whether the speed of the bike exceeds a predetermined threshold relating to the gear the bicycle gear is presently in. This determination is a basic determination that is relevant for the indicated primary shifting instruction. In case it is determined in step 42 that the speed of the bike exceeds a predetermined threshold relating to the gear the bicycle gear is in, the method continues in step 43 with a determination as to whether the pedal torque is lower than a certain predetermined threshold value. In case it is determined in step 43 that the pedal torque is lower than the certain predetermined threshold value, a shifting instruction is assembled in step 46, the shifting instruction to be transferred to the shifting control unit 33 of the bicycle shifting device 3.

However, in case it is determined in step 43 death the pedal torque threshold is above the predetermined threshold value, the method returns to step 42.

In case it is determined in step 42 that the bike speed is slower than the threshold value relating to the gear the bicycle gear is in, the flow continues in step 44. In step 44, it is determined whether the bike speed is slower than a predetermined threshold value for the shifting relating to the gear the bicycle gear is in. If it is determined in step 44 that the bike speed is not lower than the predetermined threshold value for the shifting relating to the gear the bicycle is in, the method returns to start or step 42.

In case it is determined in step 44 that the bike speed is lower than the predetermined threshold value relating to the gear the bicycle is in, the method continues in step 45. In step 45, it is determined, similarly to step 43, whether the pedal torque is below a certain predetermined threshold value. If this is not the case, the method returns to step 44 and shifting is omitted. If in step 45 it is determined that the pedal torque is below the predetermined threshold value, a shifting instruction to shift down is assembled in step 47, the shifting instruction to be transferred to the shifting control unit 33 of the bicycle shifting device 3.

As indicated in the above, the combination of steps 42 and 43 respectively 44 and 45 is indicated in this flow to provide an overview over the combination of primary and secondary shifting instructions. It is however preferred that a shifting instruction is assembled based on step 42 respectively step 44 alone, after which the primary shifting instruction is assembled by the respective processor, preferably the central controlling computer 14 of the bicycle.

Next to this assembling of the primary shifting instruction being assembled by the preferred processor of the bicycle, the secondary shifting restriction is determined and assembled by information obtained by monitoring of the torque sensor 15 of the bicycle. The torque sensor 15 of the bicycle is preferably arranged at the crank set or crank axle thereof of the bicycle. Measurements or signalling information from this torque sensor 15 are taken up by a processor that is arranged in a processing unit 16 that is arranged adjacent to the crank set of the bicycle. Processing of the signals from the torque sensor 15 by this processor in this further processing unit 16 is made on practical considerations that in this bicycle design such processing capacity is practically available at that location. Based on these considerations, it is advantageous to directly provide the secondary shifting instruction from this location such as from this processor.

In such embodiments, the primary shifting instruction and the secondary shifting instruction, from different sources. It is preferred that the primary shifting instruction is sent and received before the secondary shifting instruction is sent and received as the pedalling force can increase momentarily when the rider starts pedalling after having paused pedalling. However, as a preferred exception, if the rider has been pedalling steadily, a timing prognosis based on the cyclic nature of such study pedalling may be used in such a way that the shifting control unit can assume a pedalling force at a certain time interval based on a secondary shifting instruction that is sent and received before the primary shifting instruction. Such preferred exception may be valid for a time duration of for instance less than one cycle or for instance less than half a cycle of pedalling.

A further preferred consideration is that the electrical energy that is used as the source of electrical energy for the bicycle shifting device is formatted in this further processing unit 16. It is preferred that the shifting motor is provided with electrical power having a third voltage between a first voltage for the central controlling computer and connected subsystems and a second voltage for the drive motor. This second voltage is preferably anywhere between 12 and 36 V, preferably about 24 V. Also an electric lock of the bicycle that is arranged at the other side of the wheel is provided from this electricity source with this voltage. Such intermediate voltage provides advantages of providing enough power for such bicycle shifting device and/or lock with a relatively low current.

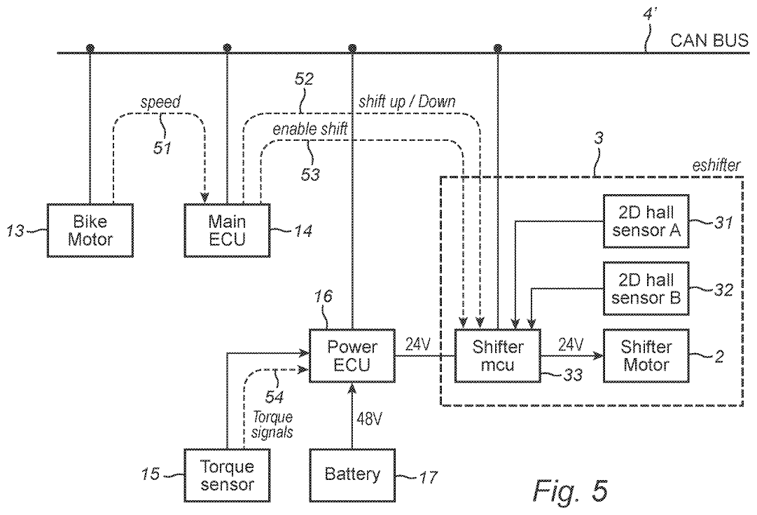

FIG. 5 shows a schematic representation of an embodiment of bicycle components and/or subsystems that are functional in the shifting of the gear of the bicycle. Of the bicycle shifting device 3, the shifting control unit 33, the shifting motor 2 and a first hall sensor 31 and a second hall sensor 32, both preferably 2D arranged, are shown.

Measuring signals of the first hall sensor 31 and the second hall sensor 32 are provided to the shifting control unit 33 for processing thereof for the purpose of providing input for assembling a control signal to control the shifting motor. The shifting module comprises a wired input 4 that is connected to a power in the data communication bus 4′ of the bicycle. This data communication bus is preferably embodied according to a CAN bus configuration and/or specification. In the shifting control unit 33 receives shifting instructions from outside the bicycle shifting device that are embodied as primary shifting instructions and/or secondary shifting instructions. As indicated elsewhere in this description, the primary shifting restrictions may be received separately from the secondary shifting instructions.

The bicycle is controlled by a central controlling computer or central board computer controlling basically the whole of the operations of the bicycle that are controlled electronically. The bicycle comprises a bicycle motor with a bicycle motor control that is in communication with the central board computer in order to control the bicycle motor. As part of these communications, the bicycle motor 13 provides a continuous stream 51 comprising bicycle speed information to the central controlling computer 14. Based on this bicycle speed information, and additional parameters such as comprising shifting conditions, the bicycle computer assembles shifting instructions 52 that are sent through this data communication bus 4′ to the shifting control unit 33 of the bicycle shifting device 3. In this embodiment, these instructions 52 are primary shifting instructions basically instructing the bicycle shifting device to perform shifting or shifting down of the gear of the bicycle. Such shifting instruction may comprise a double shifting instruction or a triple shifting instruction in case of very fast speed changes. Depending on torque signal relating considerations, and shifting speed of performing such shifting, the shifting control unit may perform such double or triple shifting instructions in one shifting operation or in separate shifting operations. An example thereof is that when a rider performs hard braking or a full stop, also pedalling stops and the pedalling force is not a consideration to perform for example a shifting from the highest gear to the lowest gear. Another example thereof is that when a rider starts a steep descent from a hill, the speed rises so quickly that an immediate double shifting up may be performed if the speed for a respective gear is reached momentarily.

The bicycle also comprises a further control unit 16 that is preferably used for providing a secondary shifting instruction according to the preferred embodiments. To this end, the further control unit 16 is in communication with a torque sensor 15 that measures torque at the location of the crank axis of the bicycle. A continuous stream of torque signals is processed by a processor of the further control unit 16, which processor also assembles a secondary shifting instruction 53 that is sent to the shifting control unit 33 of the bicycle shifting device. The further control unit, as indicated elsewhere in this disclosure, also formats a power supply to the shifting control unit 33. To this end, the further control unit is connected to a main drive battery 19 of the bicycle to obtain its exemplary 48 V power supply and transform this to a 24 V power supply for the bicycle shifting device.

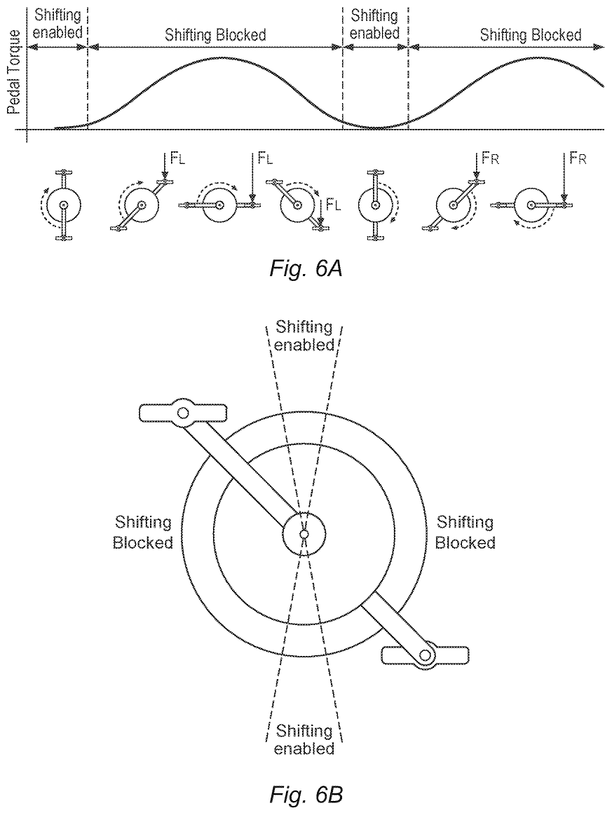

FIGS. 6A-B indicates the force cycle of the pedals that is induced by the rider onto the pedals. It is preferred that shifting is performed by the bicycle shifting device at times that the torque that is transferred onto the bicycle gear from the pedals is relatively lowest. Both schematics indicate at least one low force interval and at least one high force interval. As is indicated, this is generally the case when the pedals are substantially in the high and low position, such as when the pedals are generally oriented vertically. During lowering of the pedal, the force that a rider exerts rises initially until a maximum and subsequently lowers until a minimum. The cyclic nature of this during regular pedalling allows for some prediction as to the timing of the low force intervals over the course of time. As such, at least within a half or whole cycle, or within at least one cycle, a prediction can be made as to predictable time points following already measured time points such as under the assumption of regular pedalling.

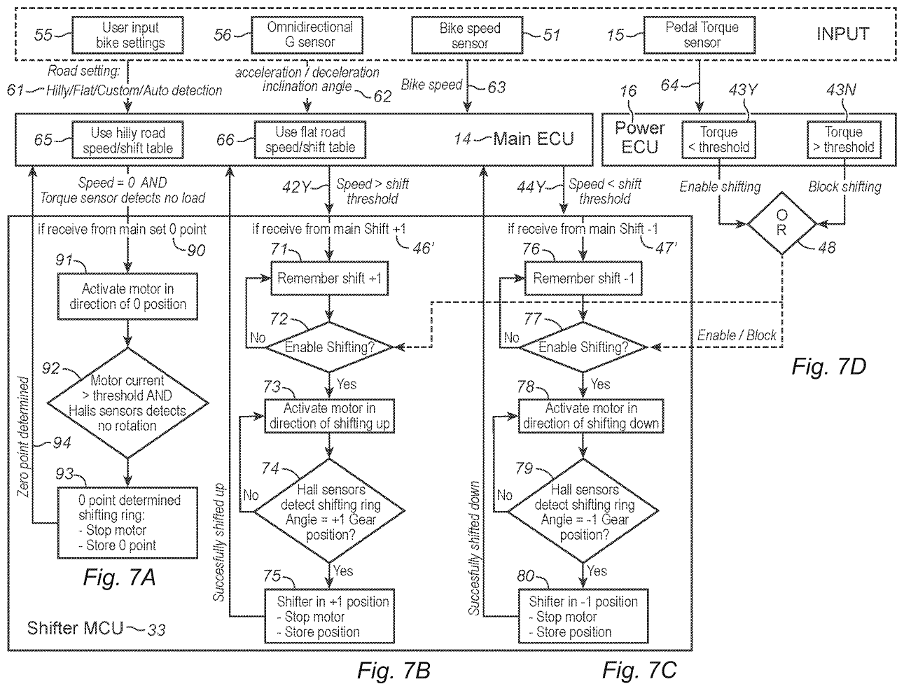

FIGS. 7A-D shows a flow of an embodiment of controlling several aspects of bicycle shifting according to this embodiment. Generally, the left column ‘A’ of steps shows steps to be performed by the shifting control unit 33 based on a bootup instruction. Furthermore, the middle column ‘B’ and the right column ‘C’ of steps shows steps to be performed based on the primary shifting instructions and/or the secondary shifting instructions.

With this, a top row of inputs is shown, comprising input that represents user input bicycle settings, such as a default table comprising speed at which shifting or shifting down from a respective gear is to be performed. The bicycle, preferably the central controlling computer comprises a data store 55 for storing default settings and preferably a data store for storing user amended settings, which settings the user may amend from an external computing device. Further preferably, the bicycle has an omnidirectional G sensor 56 that is instrumental in providing information with respect to an inclination the bike is riding at. Such sensor is preferably arranged in the same housing as the central controlling computer. Furthermore, inputs are provided from a bike speed sensor, preferably arranged in the drive motor 13 of the bike, for preferably constantly monitoring the speed of the bicycle during riding thereof and providing messages 51 comprising information relating to the current speed of the bicycle. Furthermore, the pedal torque sensor 15 is provided for preferably providing information that forms the basis of the said secondary shifting instructions. It is preferred to have the pedal torque sensor 15 monitored by a further processing unit of the bicycle wherein the further processing unit 16 of the bicycle provides the secondary shifting instruction to the shifting control unit 33 in parallel to the central controlling computer providing the primary shifting instructions to the shifting control unit 33.

The central controlling computer of the bicycle functions based on a combination of the user input bicycle settings or default settings determining up and down shift speeds for each gear together with the sensor input in his for each are according to an embodiment. Based on this, the central controlling computer 14 uses either a decision step based on regular or flat road settings 66 or based on inclined road settings 65. A decision as to which of these 2 settings is used is preferably constantly determined based on input from the omnidirectional G sensor 56. Decision steps as to switching between these two settings are not shown that understood to be disclosed within the understanding of this document. These different settings may thus be used for all outgoing messages such as the shown shift up column ‘B’ and the shift down column ‘C’.

The ‘A’ generally indicates a boot up setting for determining the 0 point of rotation of the gear actuator. The relevance thereof has also been indicated elsewhere in this document. When the bicycle switches on, such as when a user approaches the bicycle and the central controlling computer is to understand that the bicycle is to be used for a ride, it is preferred that the positioning or the position determining of the gear actuator is calibrated relative to the gear. This is preferably performed by finding a 0 point of rotation of the gear actuator. The shifting motor of the bicycle shifting device can rotate the gear actuator in the direction of the lowest gear and beyond until the end of the path of motion of the bicycle gear has been reached beyond the lowest gear. From this end of the path of motion, each gear may be reached by rotating the gear actuator thereby rotating the bicycle gear from this end of the path of motion passing all gears towards the highest gear or beyond. From this, these preferred to call the end of path of motion beyond the lowest gear the 0 point of rotation of the gear actuator.

Based on this reasoning, when the shifting control unit 33 receives instruction 90 to boot or to set such 0 point, the shifting control unit controls the at least one shifting motor 2 in step 91 to drive the gear actuator towards its end of motion. When the gear actuator 11 reaches its end of motion, the motor current rises above a predetermined threshold and the hall sensors no longer detected a movement of the gear actuator 11. Subsequently, in step 92, it is thus determined that the motor current rises above a predetermined threshold and/or it is thus determined that the hall sensors no longer detected a movement of the gear actuator 11. In case this determination is performed conclusively, in step 93, the determination is fixed as to the 0 point, the motor is stopped, and the 0 point is stored. Furthermore, a confirmation message 94 that the 0 point has been determined is sent to the central controlling computer 14. Subsequently, shifting can be performed based on predetermined and prestored rotation values that correspond with corresponding gears of the bicycle gear of the gear actuator. Based on this, step 93 and with shifting the bicycle gear to its lowest gear by rotating the gear actuator from the 0 point 2 the respective position that corresponds with the first gear of the bicycle gear. After this, and until a subsequent bootup or an intermediate recalibration of the 0 point in case of a ride with a predetermined great many shifting actions, the shifting control unit 33 controls the bicycle shifting device based on column ‘B’ or ‘C’. It may furthermore be remarked that the predetermined and prestored rotation values are preferably linked to an individual gear device. Such settings are preferably replaced with settings linked to another individual gear device upon changing of such device. Also maintenance to a gear device may require changing of such settings.

According to column ‘B’, an embodiment is disclosed as to shifting up of the bicycle gear. The central controlling device 14 is preferably functioning based on either gear shifting profile 65 or 66. Such determination is, as explained, also influenced by information as to user settings 55, an omnidirectional G sensor 56 and a bike speed sensor 51. Based on the determination in relation to step 42Y (YES in relation to or as outcome of step 42) that the central controlling device makes to assemble a shifting instruction, the shifting instruction is provided to the shifting control unit by means of a message 46′ in case the speed of the bicycle is higher than a shifting threshold of current gear that the bicycle gear is in.

Upon receipt of the instruction 46′, which is the primary shifting instruction, step 71 processes the instruction to the effect that the shifting control unit which is a state that it is to shift to the first higher gear. The shifting control unit is however also aware of the requirement of this embodiment to receive the secondary shifting instruction. Thus, in step 72, it is determined whether the shifting is to be performed. In case the secondary shifting instruction is received and comprises the information that clears the shifting to be performed, the method continues in step 73. In case the secondary shifting instruction does not clearly shifting to be performed, the method returns to step 71.

In step 73, the shifting motor 2 is activated in the direction that the gear actuator brings the bicycle gear to a higher gear. In step 74, input of hall sensors 31, 32 is monitored in order to determine whether either in the shifting motor 2 needs to be stopped and/or whether the hall sensor indicate approaching the location of the gear actuator to be at the location of the respective higher gear relative to the gear that the bicycle gear was in before shifting. In case this determination is positively made in step 74, in step 75, it is determined that the shifter has reached that this position of the higher gear, the shifting motor to is stopped and the position is stored. Furthermore, a message comprising information as to the present gear is sent to the central controlling computer 14 by the shifting control unit 33.

According to column ‘C’, an embodiment is disclosed as to shifting down of the bicycle gear. The central controlling device 14 is preferably functioning based on either gear shifting profile 65 or 66. Such determination is, as explained, also influenced by information as to user settings 55, an omnidirectional G sensor 56 and a bike speed sensor 51. Based on the determination in relation to step 44Y (YES in relation to or as outcome of step 44) that the central controlling device makes to assemble a shifting instruction, the shifting instruction is provided to the shifting control unit by means of a message 47′ in case the speed of the bicycle is lower than a shifting threshold of current gear that the bicycle gear is in.

Upon receipt of the instruction 47′, which is the primary shifting instruction, step 76 processes the instruction to the effect that the shifting control unit which is a state that it is to shift to the first lower gear. The shifting control unit is however also aware of the requirement of this embodiment to receive the secondary shifting instruction. Thus, in step 77, it is determined whether the shifting is to be performed. In case the secondary shifting instruction is received and comprises the information that clears the shifting to be performed, the method continues in step 76. In case the secondary shifting instruction does not clearly shifting to be performed, the method returns to step 71. With this, it is more common that when shifting down, pedalling is generally interrupted or less regular.

In step 78, the shifting motor 2 is activated in the direction that the gear actuator brings the bicycle gear to a lower gear. In step 79, input of hall sensors 31, 32 is monitored in order to determine whether either in the shifting motor 2 needs to be stopped and/or whether the hall sensor indicate approaching the location of the gear actuator to be at the location of the respective lower gear relative to the gear that the bicycle gear was in before shifting. In case this determination is positively made in step 79, in step 80, it is determined that the shifter has reached that this position of the lower gear, the shifting motor to is stopped and the position is stored. Furthermore, a message comprising information as to the present gear is sent to the central controlling computer 14 by the shifting control unit 33.

Furthermore, it is generally shown in column D how the secondary shifting instructions are assembled by the further processing unit 16. The pedals torque sensor 15 is monitored by the further processing unit 16 in order to determine that either the talk is below a threshold value in step 43Y (YES in relation to or as outcome of step 43), or that the torque is above such threshold in step 43N (NO in relation to or as outcome of step 43). As a result, the further processing unit 16 assembles a message with the value enable shifting order value block shifting to be used as input by the shifting control unit 33 in either shifting column ‘B’ or ‘C’.

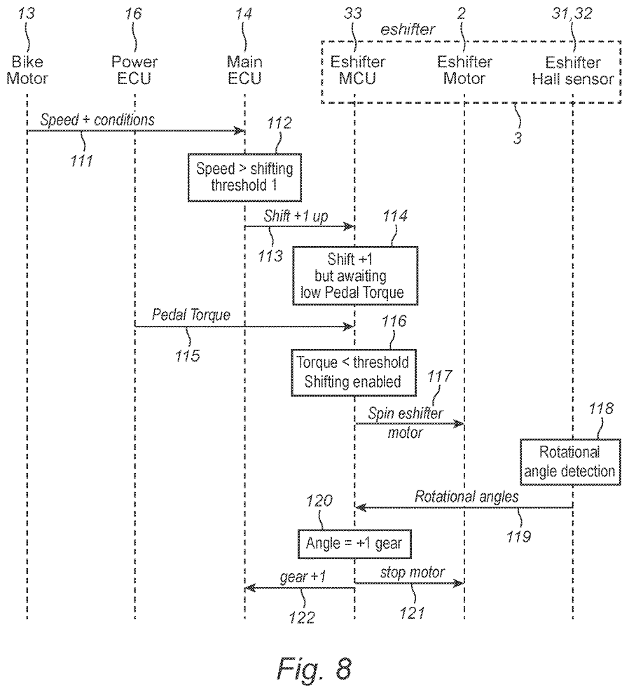

Alternatively, FIG. 8 provides an alternative embodiment for explaining preferred details of shifting of the bicycle gear. The central controlling computer 14 monitors 111 the speed of the bicycle by receiving speed information from the bicycle motor 13. Furthermore, the main controlling computer 14 functions with information as to parameters relating to shifting decisions. Such information is preferably stored in a data store that is accessible by the central controlling computer such as a memory thereof. Such information has been indicated elsewhere in this document as input information determining at what speeds shifting towards what gears is to be determined. The communications between the several subsystems of the bicycle are performed via the otherwise indicated data communication bus, such as a can bus.

In step 112, it is determined at the central controlling computer 14 that the speed is higher than a threshold speed for the current gear. Based on this determination, a message 113 that the gear is to be shifted up one gear is sent to the shifting control unit 33 of the bicycle shifting device 3. Based on receipt of this message 113, the shifting control unit performs the determination that shifting upward by one gear is to be performed. The shifting control unit also performs the determination that this was the primary shifting instruction and that the secondary shifting instruction is not present, if this is the case. In parallel to the determination that a shifting is to be performed by the central controlling computer, the further processing unit 16 performs the determination whether the pedal torque is suitable for performing a shifting operation or the further processing unit performs the determination at what future timing the pedal torque will be suitable for shifting based on the nature of the cycle of the pedal torque as exerted to the pedal by the rider. The further processing unit 16 subsequently to such determination sends a respective message 115 to shifting control unit 33 via the data bus. This message serves the purpose of the secondary shifting instruction according to this embodiment.

Subsequent to receiving the message 115 by the shifting control unit 33 the shifting control unit performs the determination 116 that a shifting is to be performed as the pedal torque value is below the threshold value. As also the shifting instruction of message 113 had been received, the shifting control unit performs controlling 117 of the shifting motor by starting to provided with power. In parallel, the location sensor that is preferably embodied by the combination of 2 hall sensors monitors the displacement of the gear actuator, such as the rotation thereof in this embodiment. The location sensor 31, 32 provides its sensory data to the shifting control unit 33. Based on this sensory data it makes the determination in step 120 that providing power to the shifting motor is to be stopped at the appropriate time or displacement of the gear actuator. In step 121, the actuation of the shifting motor is stopped. In step 122, a message is sent via the data bus of the bicycle to the central controlling computer that the shifting is be performed and that the bicycle is in the gear that was indicated in the instruction message 113.

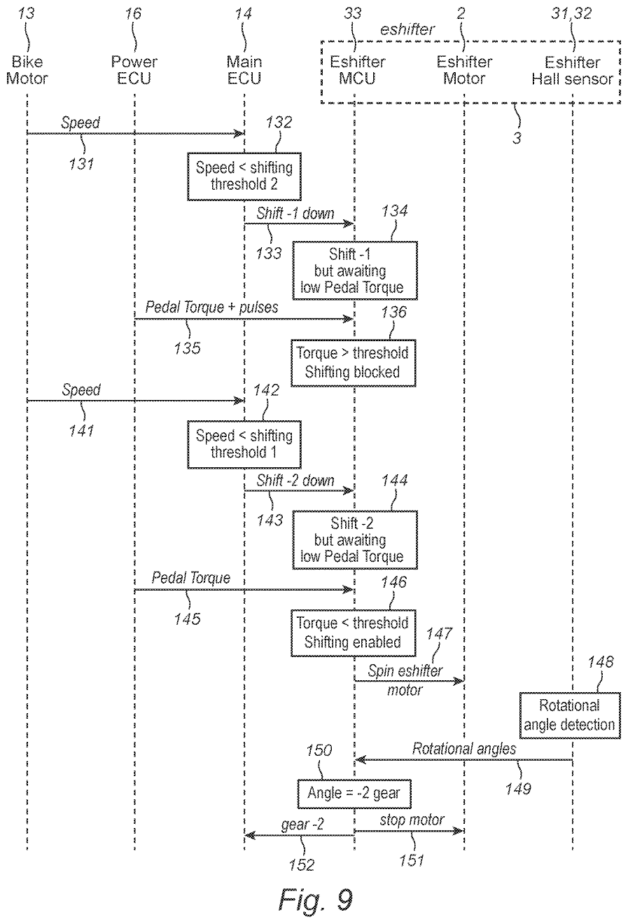

FIG. 9 provides a further alternative embodiment for explaining preferred details of shifting of the bicycle gear. The central controlling computer 14 monitors 131 the speed of the bicycle by receiving speed information from the bicycle motor 13. Furthermore, the main controlling computer 14 functions with information as to parameters relating to shifting decisions. Such information is preferably stored in a data store that is accessible by the central controlling computer such as a memory thereof. Such information has been indicated elsewhere in this document as input information determining at what speeds shifting towards what gears is to be determined. The communications between the several subsystems of the bicycle are performed via the otherwise indicated data communication bus, such as a can bus.

In step 132, it is determined at the central controlling computer 14 that the speed is lower than a threshold speed for the current gear. Based on this determination, a message 133 that the gear is to be shifted down by a gear is sent to the shifting control unit 33 of the bicycle shifting device 3. Based on receipt of this message 133, the shifting control unit performs the determination that shifting down by one gear is to be performed. The shifting control unit also performs the determination that this was the primary shifting instruction and that the secondary shifting instruction is not present, if this is the case. In parallel to the determination that a shifting is to be performed by the central controlling computer, the further processing unit 16 performs the determination whether the pedal torque is suitable for performing a shifting operation or the further processing unit performs the determination at what future timing the pedal torque will be suitable for shifting based on the nature of the cycle of the pedal torque as exerted to the pedal by the rider. However, in this case, the further processing unit 16 determines that the paddling torque is higher than the threshold and the shifting is to remain blocked and subsequently to such determination sends a respective message 135 to shifting control unit 33 via the data bus. This message serves the purpose of the secondary shifting instruction according to this embodiment. Based upon this message, the shifting control unit 33 determines 136 that shifting is not to be performed. This also means that no confirmation is sent back from the shifting control unit 33 to the central controlling computer 14.

The method continues by central controlling computer 14 monitoring 141 the speed of the bicycle by receiving speed information from the bicycle motor 13. Furthermore, the main controlling computer 14 functions with information as to parameters relating to shifting decisions.

In step 142, it is determined at the central controlling computer 14 that the speed is lower than a threshold speed for the current gear. Based on this determination, a message 143 that the gear is to be shifted down by two gears is sent to the shifting control unit 33 of the bicycle shifting device 3. Based on receipt of this message 143, the shifting control unit performs the determination that shifting down by one gear is to be performed. The shifting control unit also performs the determination that this was the primary shifting instruction and that the secondary shifting instruction is not present, if this is the case.

In parallel to the determination that a shifting is to be performed by the central controlling computer, the further processing unit 16 performs the determination whether the pedal torque is suitable for performing a shifting operation or the further processing unit performs the determination at what future timing the pedal torque will be suitable for shifting based on the nature of the cycle of the pedal torque as exerted to the pedal by the rider. The further processing unit 16 subsequently to such determination sends a respective message 145 to shifting control unit 33 via the data bus. This message serves the purpose of the secondary shifting instruction according to this embodiment.

Subsequent to receiving the message 145 by the shifting control unit 33 the shifting control unit performs the determination 146 that a shifting is to be performed as the pedal torque value is below the threshold value. As also the shifting instruction of message 143 had been received, the shifting control unit performs controlling 147 of the shifting motor by starting to provided with power. In parallel, the location sensor that is preferably embodied by the combination of 2 hall sensors monitors the displacement of the gear actuator, such as the rotation thereof in this embodiment. The location sensor 31, 32 provides its sensory data to the shifting control unit 33. Based on this sensory data it makes the determination in step 150 that providing power to the shifting motor is to be stopped at the appropriate time or displacement of the gear actuator. In step 151, the actuation of the shifting motor is stopped. In step 152, a message is sent via the data bus of the bicycle to the central controlling computer that the shifting is be performed and that the bicycle is in the gear that was indicated in the instruction message 143.

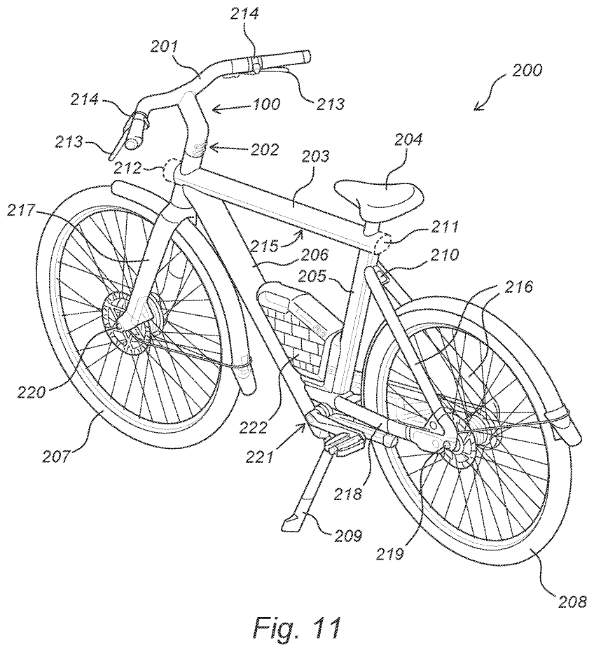

FIG. 11 shows a schematic overview of a bicycle 200 according to the invention. The bicycle 200 comprises a frame comprising a top tube 203, a seat tube 205, a bottom tube 206, a pair of seat stays 216, and a pair of chain stays 218. At the rear axis 219 a rear wheel 208 is rotatably arranged. The rear wheel may be powered by a used via a crank set 221. In order to drive de bicycle 200, the front side of the bicycle may comprise a handlebar 201, which may be rotatable with respect to the head tube 202 of the bicycle. The handlebar 201 may rotate the front wheel 207 which is arranged rotatably on a front axis 220. Said front wheel 207 may be held into place by means of the fork 217 which is rotatably coupled to the handlebar 201 of the bicycle 200. The handlebar 201 may be provided with a brake system 213 for allowing a user to apply a braking force. The handlebar 201 may comprise a first control unit 100, preferably arranged in a stem of the bicycle. Said first control unit may allow the accessory cables of the electronic accessories of the handlebar to be routed at least partially, preferably substantially entirely inside the frame of the bicycle 200. The first control unit 100 allows to reduce the amount of cables running through a steerer tube. One or more optical feedback units 214 may be arranged on and/or in the handlebar 201 for providing the user with optical feedback related to a bicycle status. Inside the bottom tube 206 a primary battery may be arranged for driving at least one electric motor which is arranged in the front axis 220 and/or rear axis 219. Optionally, a secondary battery 222 may be provided for extending the range of the bicycle 200. The primary battery inside the bottom tube 206 and/or the secondary battery 222 may be charged via a charging port 210 of the bicycle 200. The charging port 210 is arranged on a rear side of the bicycle in order to be easily accessible for a user. In this particular embodiment, the charging port 210 is arranged between the pair of seat stays 216 and attached to the seat tube 205 of the bicycle 200. In order for easily connecting the bicycle 200 to an external service device a service port 215 may be provided. In this embodiment the service port 215 is provided on a bottom side of the top tube 203 of the bicycle. Inside the top tube 203 at least one bicycle control unit may be provided. It is imaginable that at least one exposed exterior surface of at least one frame part comprises at least one antenna system. Said antenna system may be directly or indirectly mounted to said bicycle frame 203, 205, 206, 212, 216. The seat tube 205 further accommodates the seat post which may be attached to the saddle 204 of the bicycle 200. In order to increase the visibility of the user of the bicycle 200 during the evening or in the night time, the bicycle 200 may be provided with a front light module 212 and/or a rear light module 211. Said front light module 212 and rear light module 211 may allow for dynamic light patterns and/or for emitting light in at least a left and/or right direction. The bicycle 200 as shown in this figure is merely illustrative for the components thereof. It is explicitly noted that some aspects of the bicycle 200 as shown in this figure may be chosen by way of design. In particular shapes of the light modules 212, 211 may at least partially be shaped by design. Moreover, the shape of the tubes 202, 203, 205, 206 of the bicycle may also at least partially be chosen by way of design. Hence, the aesthetical appearance of the depicted embodiment are matters of design choice and can be varied or eliminated as desired.

Further definitions. A preferred definition of the pedal torque as used in this document is the torque exerted by the rider onto the pedals such as is transferred by the chain from a driven sprocket to the rear sprocket of the bicycle. With this, it is expressly clarified that for the purpose of shifting of gears, a low exerted force by the chain onto the gear allows for better and/or faster shifting of gears. Opposed to this, when a high forces exerted by the chain onto the gear the gear is likely to remain stuck in the present gear and therefore hampered to switch over to another gear.

The invention is further illustrated by way of the non-limitative set of clauses presented below.

### Clauses

1. Bicycle shifting device comprising:
a shifting control unit for receiving of shifting instructions from the central controlling computer or a further control unit, comprising a processing unit and a memory,
a power receiving module, such as comprising an electrical connector, for receiving power from a battery of the central controlling computer, and/or the main control unit and/or a drive motor battery of the bicycle,
at least one shifting motor, such as an electric motor, such as a stepper motor for providing a shifting motion for driving a shifting assembly for actuating of a gear actuator,
the shifting assembly being configured to transfer the shifting motion from the shifting motor to the gear actuator,
the gear actuator being configured to transfer the shifting motion to the bicycle gear,
wherein the bicycle shifting device comprises a positioning determining assembly, such as an angular position determining assembly, for determining of a position, such as an absolute position or an absolute angular position of the gear actuator relative to at least one sensor.
2. Bicycle shifting device according to clause 1 comprising any feature according to any of the attached claims or the above description.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component. By “complementary” components is meant that these components are configured to co-act with each other. However, to this end, these components do not necessarily have to have complementary forms. The verb “comprise” and conjugations thereof used in this patent publication are understood to mean not only “comprise”, but are also understood to mean the phrases “contain”, “substantially consist of”, “formed by” and conjugations thereof.

It will be apparent that the invention is not limited to the working examples shown and described herein, but that numerous variants are possible within the scope of the attached claims that will be obvious to a person skilled in the art. The aesthetical appearance and design of the working examples or details thereof, in particular as shown in the appended figures, is not technically determined, unless indicated otherwise, and is merely incorporate to demonstrate and clarify the inventive concept(s) described herein. Hence, the aesthetical appearance of the depicted embodiments are matters of design choice and can be varied or eliminated as desired. The owner of this patent document does moreover not disclaim any other rights that may be lawfully associated with the information disclosed in this document, including but not limited to, copyrights and designs associated with, based upon, and/or derived from the appended figures.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. A bicycle with a central controlling computer for controlling subsystems of the bicycle, the bicycle comprising a bicycle shifting device for shifting of a bicycle gear the bicycle shifting device comprising:
a shifting control unit for receiving of shifting instructions from the central controlling computer or a further control unit, comprising a processing unit and a memory,
a power receiving module for receiving power from a battery of the central controlling computer and/or a drive motor battery of the bicycle,
at least one shifting motor for providing a shifting motion for driving a shifting assembly for actuating of a rotatable gear actuator of the bicycle shifting device,
the shifting assembly being configured to transfer the shifting motion from the shifting motor to the gear actuator,
the gear actuator being configured to transfer the shifting motion to the bicycle gear, wherein:
the shifting control unit, by means of communication with and controlling by the central controlling computer of the bicycle, is configured as a subsystem of the bicycle, and
the shifting control unit shifts the bicycle gear on the basis of shifting instructions, in particular primary shifting instructions and/or secondary shifting instructions, from the central controlling computer, the motor control unit, and/or a further control unit,
wherein the bicycle shifting device comprises a positioning determining assembly, for determining of an absolute position of the gear actuator relative to at least one sensor of the positioning determining assembly, and wherein the positioning determining assembly comprises the at least one magnetic field sensor for performing magnetic field measurements, and wherein the gear actuator is provided with an annular array of consecutive magnets along its substantially entire circumference or periphery, wherein most of said magnets of said annular array are arranged in an alternately north-south arrangement, and wherein the remaining magnets define at least one series of at least two consecutive magnets having the same polarity arrangement.

2. The bicycle according to claim 1, wherein the annular array of magnets comprises at least one series of at least three consecutive magnets having the same polarity arrangement.

3. The bicycle according to claim 1, wherein the annular array of magnets comprises at least two series of at least two consecutive magnets having the same polarity arrangement.

4. The bicycle according to claim 1, in which two sensors are arranged at a mutual distance for detecting passage of consecutive magnets.

5. The bicycle according to claim 1, wherein the positioning determining assembly comprises at least two hall sensors, mutually positioned at a distance d, and wherein at least one series of at least two consecutive magnets having the same polarity arrangement has a width, in particular a curved width, wherein said width exceeds said distance d between said at least two hall sensors and/or wherein the shortest distance between at least one sensor and the annular array of magnets is smaller than the width of at least one magnet.

6. (canceled)

7. The bicycle according to claim 1, comprising program code for analysing sensor data of the at least one sensor, arranged for determining the position of the gear actuator based on the measurements of the sensor on the array of consecutive magnets.

8. The bicycle according to claim 1, comprising a torque sensor for measuring a torque exerted by means of pedalling power by the rider of the bicycle as providing a torque measurement signal, the shifting control unit being arranged for receiving the torque measurement signal originating from the torque sensor in which the shifting control unit is configured receive a secondary shifting instruction to prevent shifting when the torque measurement signal indicates a torque above a threshold value, and to allow shifting when the torque measurement signal indicates a torque below a threshold value.

9. (canceled)

10. The bicycle according to claim 8, comprising a predictor module for predicting of a time period during which the torque will be below the threshold value.

11. The bicycle according to claim 1, wherein the shifting control unit only initiates and/or performs a shifting after receipt of at least one primary shifting instruction from the central controlling computer and/or a secondary shifting instruction comprising a torque measurement signal and/or comprising a storage and processing module for a rider defined shifting profile.

12. (canceled)

13. The bicycle according to claim 1, having a data store comprising data indicating for each gear the position the gear actuator should have relative to a calibration point or start point.

14. The bicycle according to claim 1, having a control unit that is configured to perform a bootup sequence comprising steps of:
displacing
determining this end of its rotational path as the calibration point or the start point of functioning from bootup,
subsequently rotating the gear actuator to the position of the lowest or first gear.

15. The bicycle according to claim 1, having a control unit configured to perform a monitoring sequence comprising steps of continuously monitoring the position or angular position of the gear actuator by the sensor having a control unit, which makes part of the shifting control unit, configured to perform controlling of the shifting motor based on the continuous monitoring of the position or angular position of the gear actuator by the sensor.

16. (canceled)

17. The bicycle according to claim 1, comprising a control unit configured to perform assembling shifting instructions for the shifting control unit.

18. The bicycle according to claim 1, comprising a control unit configured to perform monitoring the bicycle speed as an input in order to determine a shifting moment based on the speed of the bicycle.

19. The bicycle according to claim 1, comprising a further control unit configured to perform monitoring an inclination sensor of the bicycle as an input in order to perform determining of a shifting moment also based on the inclination of the bicycle.

20. The bicycle according to claim 1, wherein the bicycle comprises a torque sensor for measuring a torque exerted by means of pedalling power by the rider of the bicycle as providing a torque measurement signal the shifting control unit being arranged for receiving the torque measurement signal originating from the torque sensor, and wherein the bicycle comprises a speed sensor for measuring the speed of the bicycle and configured to provide a speed measurement signal, the shifting control unit being arranged for receiving the speed measurement signal originating from the speed sensor, and wherein at least one control unit is configured to provide a shifting instruction based upon the combination of the collected torque measurement signal and the collected speed measurement signal.

21. The bicycle according to claim 1, in which the bicycle gear is a hub gear arranged in the rear hub of the bicycle and/or comprising a temperature sensor for sensing a temperature in the bicycle shifting device.

22. (canceled)

23. The bicycle shifting device for use in a bicycle according to claim 1.

24. A method for performing shifting of gears of a bicycle the method comprising steps of:
monitoring at least one sensor of a group of sensors comprising a gear actuator position sensor by respectively a central controlling computer, a shifting control unit or a further control unit of the bicycle.
assembling a primary shifting instruction indicating shifting of at least one gear up or down,
assembling a secondary shifting instruction indicative of a torque threshold value,
controlling of a shifting motor based on the respective shifting instructions.

25. The method for performing shifting of gears according to claim 24 comprising a calibration and/or bootup sequence comprising steps of:
rotating the gear actuator to an end of its rotational path,
determining this end of its rotational path as calibration point or start point of functioning from bootup,
rotating the gear actuator to the position of the lowest or first gear.
